(19) United States
(12) Patent Application Publication
(10) Pub. No.: US 2011/0180683 A1
(43) Pub. Date: Jul. 28, 2011

(54) Versatile Flag Pole Bracket

(76) Inventors: Robert L. Lach, Cincinnati, OH (US); Daniel R. Lach, Cincinnati, OH (US)

(21) Appl. No.: 12/797,368

(22) Filed: Jun. 9, 2010

Related U.S. Application Data
(63) Continuation of application No. 29/354,326, filed on Jan. 22, 2010, now Pat. No. D639206.

(51) Int. Cl. G09F 17/00

(52) U.S. Cl. 248/538

(57) ABSTRACT

A versatile flag pole bracket includes two flag pole receptors in a first common horizontal plane and two side mounted windsock receptors in a second common horizontal plane that is spaced from and parallel to the first common vertical plane. The flag pole receptors accommodate a horizontal or an angled flag pole, and the windsock receptors likewise accommodate a horizontal or an angled windsock pole, thereby optimizing the versatility of the bracket. The compact size and shape of the bracket enhances its structural integrity, thereby minimizing breakage.

### RELATED APPLICATION

The present application claims priority to U.S. Ser. No. 29/354,326 filed on Jan. 22, 2010, the disclosure of which is hereby incorporated herein by reference, in its entirety.

### FIELD OF THE INVENTION

This invention relates to a device for mounting hanging decor, such as decorative flags, banners, windsocks, and planters on a planar surface, typically a vertical wall.

### BACKGROUND OF THE INVENTION

Traditional and decorative flags have become an increasingly popular way to adorn or decorate a home or other building. Such flags are usually mounted on flag poles. Hanging windsocks also enjoy significant popularity. Windsocks tend to hang from poles that are smaller in diameter than typical flag poles.

U.S. Pat. No. RE 35,731, entitled “Flag Pole Bracket,” (the “Reissued '731 patent”) discloses a versatile flag pole bracket that accommodates a typical flag pole and a typical windsock pole of smaller diameter. The device of the Reissued '731 patent provides some degree of versatility in that it defines two separate positions for holding a typical flag pole, with one position substantially horizontal and one angled at about 45° from a wall-mounted base.

The device of the Reissued '731 patent includes three receptors to accommodate these various options for hanging decor. More specifically, two receptors are sized to receive a traditional flag pole, and one smaller size receptor is sized to receive a typical windsock pole. This third receptor is located on top of the device, so as to be angled about 45° with respect to the base. The larger sized flag pole receptors share a common anchor position, located adjacent the base. A set screw can be used to secure a flag pole located in either of the two flag pole receptors, with the set screw located at the anchor position. All of the receptors reside in the same vertictal plane.

The flag pole bracket of the type disclosed in the Reissued '731 patent has enjoyed a substantial degree of commercial success. Nonetheless, it suffers from some limitations. For instance, because the anchor portion of this device is sized to accommodate a flag pole in two different orientations, it necessarily provides a rather loose fit for the flag pole. For this reason, it is almost always necessary to use the set screw to assure holding of the flag pole, even in the 45° position. This can be an inconvenience for the user.

Also, most of the brackets of this type are used with a flag in the horizontal orientation. Some sources indicate that up to 95% of usage may be in the horizontal orientation. With a flag pole held in the horizontally oriented flag pole receptor, there is more stress on the outer portion of the receptor and the anchor portion of the bracket. This stress, which can be caused by pulling on the flag or the flag pole, or by wind or other forces, can lead to breakage of the horizontal receptor. The bracket is not easy to repair in a cost-effective manner. As a result, once such breakage occurs, the device becomes useless for holding a horizontally oriented flag, and is often discarded by the owner.

In addition to the Reissued '731 patent, U.S. Pat. No. 6,726,170, entitled “Dual Position Flag Pole Bracket,” discloses a device for accommodating a typical flag pole in either a horizontal orientation or a 45° orientation. Similar to the device of the Reissued '731 patent, the device of the '170 patent has a common portion which may house one end of the flag pole when either in the horizontal orientation or the 45° orientation. However, with the device of the '170 patent, this common portion is spaced laterally away from the base and from the wall. In a sense, the '170 patent discloses a device with two flag pole receptors that intersect at a common portion that is spaced away from the wall. The device of the '170 patent does not include any smaller size receptors to accommodate a windsock. In fact, because the common portion is spaced away from the base, there is not enough space on the top of the 41° receptor to accommodate a similarly angled windsock receptor, as is provided by the device of the Reissued '731 patent.

For each of these prior brackets, if the user wants to replace a horizontal flag with another horizontal flag, or an angled flag, the user must manipulate the set screw to accommodate retraction of the in-place flag pole and insertion of the new flag pole.

It is an object of the present invention to overcome the limitations of prior art flag pole brackets of the type described, while also offering the user more options and versatility with respect to various hanging decor.

It is another object of the present invention to achieve a high degree of versatility for a flag pole bracket, while reducing the likelihood of breakage of one or more of the receptors.

### SUMMARY OF THE INVENTION

The present invention achieves the above-stated objects with a bracket that, due to its compact size and shape, is less susceptible to breakage, while also being able to accommodate two flag pole positions in a common vertical plane and two windsock pole positions in a second, different common vertical plane. More particularly, the bracket includes two intersecting flag pole receptors located in a first vertical plane. On their respective side surfaces these two flag pole receptors carry two corresponding windsock pole receptors, in a second vertical plane that is spaced from and parallel to the first plane.

According to a preferred embodiment, the invention contemplates two solid flag pole receptors mounted to a base, where the base is adapted to be mounted to a flat surface such as a wall. One of the flag pole receptors extends substantially horizontally from the wall and base. The other of the flag pole receptors extends at an angle of about 45° from the wall and the base. These two receptors intersect at a common portion spaced away from the base. The horizontal receptor includes a bottom lip that extends outwardly from the base beyond the common portion. The two flag pole receptors reside in the same vertical plane. Also, each of the flag pole receptors carries, on its side surface, a smaller windsock receptor. These smaller receptors are tubular in shape, similar to the larger receptors, but are smaller in diameter and in length. These windsock receptors also reside in a common vertical plane, but in a vertical plane that is spaced from the vertical plane of the flag pole receptors.

Because the windsock receptors are side mounted, the bracket accommodates the hanging of a windsock right next to a corresponding flag pole. Also, this orientation of the windsock receptors, with the corresponding flag pole receptor in the background, may make it easier for a user to insert the windsock pole.

The base includes mounting holes for securing to a flat surface, such as a wall, or by screw. Also, the first flag pole receptor includes a set screw hole, to accommodate extension therethrough of a set screw, so as to hold a flag pole that has been placed therein. Because this set screw hole is associated solely with the horizontally oriented receptor, it is not necessary to manipulate it when changing flags held by the angled flag pole receptor. In fact, the set screw may remain fully threaded into the set screw hole, for safekeeping, thereby minimizing the possibility of it falling out and getting lost.

This structure is relatively compact and sturdy, and thereby reduces the susceptibility to breakage. Also, compared to the device of the Reissued '731 patent, the manufacturing tolerances of the flag pole receptors adjacent the base can be tightened, because at that location each receptor must accommodate only one typical flag pole size and one orientation, rather than two different flag pole orientations.

These and other features of the invention will be apparent to a person skilled in the art, based on the drawings and the following detailed description of the drawings.

### BRIEF DESCRIPTION OF THE DRAWINGS

FIG. 1 is a perspective view of a flag pole bracket according to a first preferred embodiment of the invention, with a flag mounted on the angled flag pole receptor.

FIG. 2A is an enlarged, perspective view of one side of the flag pole bracket shown in FIG. 1.

FIG. 2B is an enlarged perspective view, similar to FIG. 2A, of an opposite side of the flag pole bracket shown in FIG. 1.

### DETAILED DESCRIPTION OF THE INVENTION

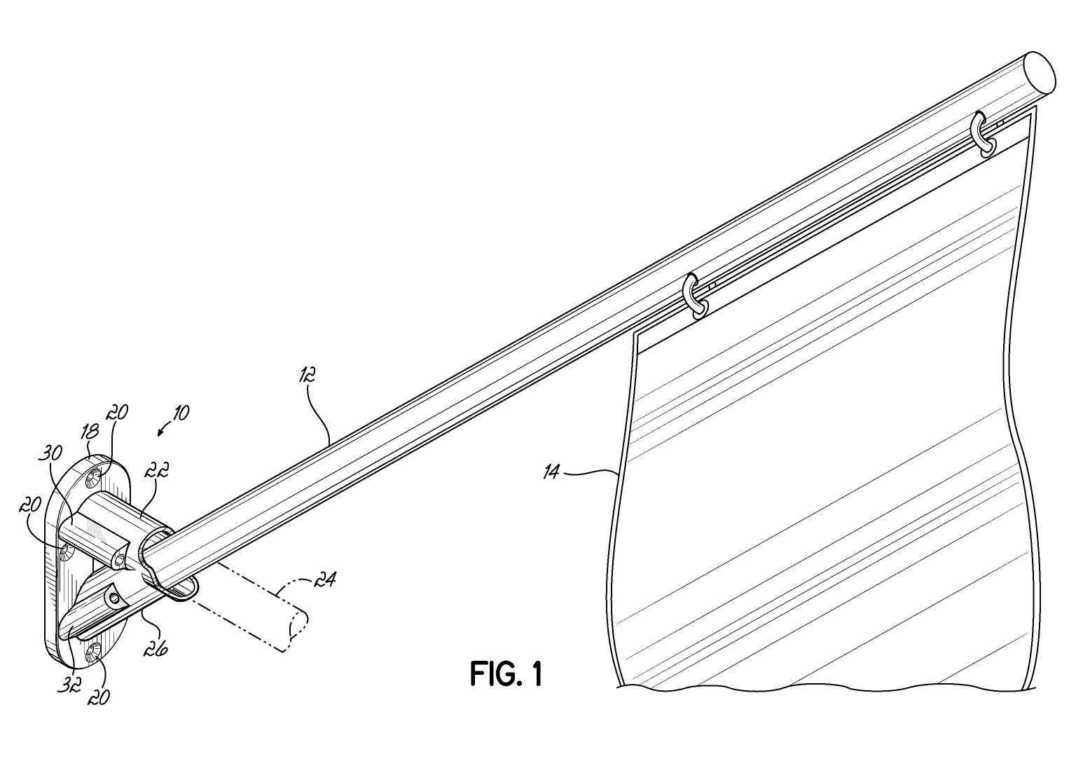

FIG. 1 shows a multi-purpose flag pole bracket 10 for accommodating different types of hanging decor at two different angles. More particularly, FIG. 1 shows a typically size flag pole 12 mounted to the bracket 10 and holding a flag 14. The Reissued '731 patent and the '170 patent are expressly incorporated by reference herein, in their entireties.

The bracket 10 includes a base 18 which is planar in shape and adapted to engage a flat surface, such as a wall, for mounting thereon. More particularly, the base 18 includes mounting holes 20 sized and shaped to accommodate screws (not shown) for mounting the bracket 10 to the flat surface.

The bracket 10 includes a first horizontally oriented flag pole receptor 22 adapted to hold a typically sized flag pole, shown in phantom via reference numeral 24, at an orientation that is horizontal to the ground, and also perpendicular or orthogonal to the base 18. The flag pole bracket 10 also includes a second angled flag pole receptor 26 sized and shaped to hold a typical flag pole of the type shown in FIG. 1, via reference numeral 12.

The multi-purpose flag pole bracket 10 includes a first horizontal windsock pole receptor 30 adapted to hold a windsock pole in a horizontal orientation, and a second angled windsock pole receptor 32, adapted to hold a windsock pole (now shown) at an angled orientation. Although these smaller sized receptors are referred to as windsock receptors, it is to be understood that they are capable of holding any correspondingly sized pole which holds any type of handing decor. Similarly, the larger sized flag pole receptors are not to be construed as limited to holding flag poles, but any other pole of the same size for supporting hanging decor.

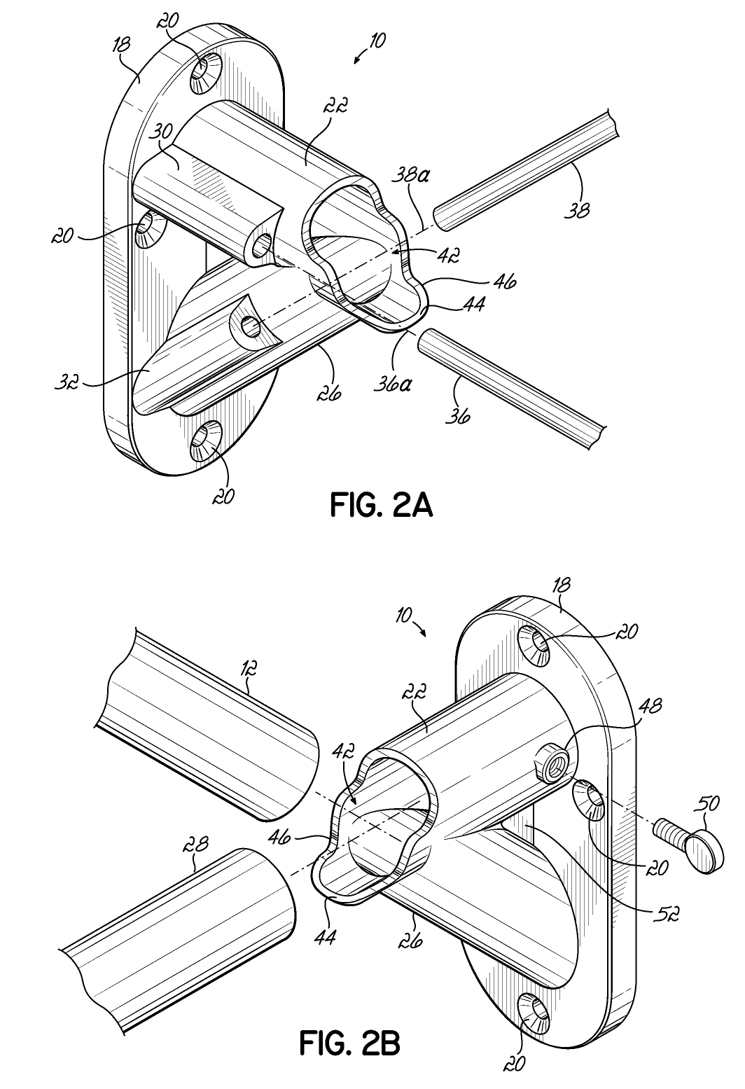

FIG. 2A shows a first windsock pole 36 aligned along an axis 36a of first windsock pole receptor 30, and a second windsock pole 38 aligned along an axis 38a of second windsock pole receptor 32. Thus, with this structure, in both the angled portion of the bracket 10 and the horizontal portion of the bracket 10, the larger sized receptors 26 and 32 and the smaller sized receptors 22 and 30 are located in a side by side relationship. This enables a flag pole and a windsock pole to be mounted alongside each other, if desired, for one of the two orientations.

As shown in FIG. 2A, the first flag pole receptor 22 and the second flag pole receptor 26 intersect each other at a common portion 42 that is spaced away from the base 18. Outwardly from this common portion 42, relative to the base 18, the bracket 10 includes a lower lip 44, which is actually the outermost part of the first flag pole receptor 22. This lower lip 44 helps to maintain the horizontal orientation of a flag pole (not shown) mounted therein. FIG. 2A also shows that the common portion 42, including the lower lip 44, defines an outermost edge 46 that extends completely around the first flag pole receptor 22 and the second flag pole receptor 26. This outermost edge 46 is arcuately curved so as to supply no sharp edges that might cut the finger of a user. This outermost edge 46 also provides an aesthetically pleasing appearance for the outermost edge of the tubes from which the first flag pole receptor 22 and the second flag pole receptor 26 are formed.

Those skilled in the art will readily appreciate that this outer edge 46 could take on a number of different configurations, depending upon the manner in which the bracket 10 is made. Preferably, the bracket 10 is made from an aluminum alloy, although other materials could be equally suitable. In its simplest form, the bracket 10 could be made by forming the base 18, along with the first and second receptors 22 and 26, and then joining them together at the appropriate angle and orientation, and cutting and/or finishing outer edge 46 so as to achieve desired shape and common portion 42. Thereafter, smaller sized first and second receptors could be secured to the sides of the larger receptors 22 and 26. Alternatively, the entire bracket 10 could be made by molding.

FIG. 21B shows a wall 52 that spans the space between the first flag pole bracket receptor 22 and the second flag pole bracket receptor 26. Preferably the first flag pole bracket 22 includes a set screw hole 48 sized and shaped to accommodate a threaded set screw 50, for securing innermost end of a flag pole 28 inserted in first flag pole receptor 22. Because of the angled orientation of the second flag pole receptor 26, a similar set screw hole and set screw is not necessary for the second flag pole receptor 26, although such structure could be added, if desired.

In use, the bracket 10 enables the user to mount a conventional flag pole in the horizontal orientation, secured to the bracket 10, or at an angled orientation, angled 45° with respect to the base 18 and the wall that the base 18 of the bracket 10 is attached to. Also, the bracket 10 enables the user to insert a windsock pole into either the first windsock pole receptor 30 or the second windsock receptor 32.

It is understood that these Figures and this detailed description represent one preferred exemplary embodiment of the present invention. Those skilled in the art will readily appreciate that one or more modifications could be made to the structure shown and described herein, without departing from the principles of the invention. In that respect, the exemplary embodiment shown and described is meant to represent merely one subset of the broader claims appended to the end of this application. And rather than the Figures and this description, it is the claims which set forth the scope of the exclusionary right which the applicants seek with respect to this present application.

We claim:

1. A flag pole bracket comprising:
a base;
a first flag pole receptor extending from the base at an angle substantially orthogonal thereto;
a second flag pole receptor extending from the base on an angle that is about 45° with respect thereto, the first and second flag pole receptors residing in a first common vertical plane;
a first windsock receptor carried on a side of the first receptor; and
a second windsock receptor carried on a side of the second receptor.

2. The flag pole bracket of claim 1 wherein:
the first and second flag pole receptor intersect at a common portion spaced for the base,

3. The flag pole bracket of claim 1 wherein:
the base is planar in shape and adapted to mount to a flat surface, the base includes at least two mounting holes for mounting the base to the flat surface.

4. The flag pole bracket of claim 1 wherein the first and second windsock receptors are located on the same side of the bracket.

5. The flag pole bracket of claim 4 wherein the first and second windsock receptors reside in a second common vertical plane that is spaced from the first common vertical plane.

6. The flag pole bracket of claim 1 further comprising:
a set screw hole associated with the first flag pole receptor and adapted to receive a set screw to hold a flag pole located therein.

7. The flag pole bracket of claim 4 further comprising:
a set screw hole associated with the first flag pole receptor and adapted to receive a set screw to hold a flag pole located therein;
the set screw hole located on an opposite side of the bracket from the first windsock receptor.

8. The flag pole bracket of claim 1 wherein each of the first and second flag pole receptors is solid along its entire length, with no openings.

9. The flag pole bracket of claim 1 further comprising:
a wall spanning the space between the first and second flag pole receptors.
